(19) United States
(12) Patent Application Publication
(10) Pub. No.: US 2009/0311436 A1
(43) Pub. Date: Dec. 17, 2009

(54) Conductive composite materials with graphite coated particles

(75) Inventors: Lawrence T. Drzal, Okemos, MI (US); Wanjun Liu, East Lansing, MI (US); Hiroyuki Fukushima, Lansing, MI (US); InHwan Do, Lansing, MI (US)

Correspondence Address: Ian C. McLeod;IAN C. MCLEOD, P.C., 2190 Commons Parkway, Okemos, MI, 48864, US

(73) Assignee: Board of Trustees of Michigan State University, Lansing, MI (US)

(21) Appl. No.: 11/897,723

(22) Filed: Aug. 31, 2007

Related U.S. Application Data
(63) Continuation-in-part of application No. 11/801,261, filed on May 9, 2007.
(60) Provisional application No. 60/800,604, filed on May 16, 2006.

(51) Int. Cl. B05D 7/24; H01B 1/24; B32B 1/00

(52) U.S. Cl. 427/485; 252/511; 428/403; 427/215

(57) ABSTRACT

Low resistivity graphite coated particles having exfoliated and pulverized graphite platelets coated on an outer surface of high resistivity particles are provided. Various methods are also provided for surface coating of the graphite platelets onto the particles to increase particle conductivity. The graphite coated particles can be used to produce reinforced composite materials. Reinforced composite materials incorporating the graphite coated particles can be electrostatically painted without using a conductive primer on the composite.

### CROSS-REFERENCE TO RELATED APPLICATIONS

This application is a continuation-in-part of U.S. patent application Ser. No. 11/801,261, filed May 9, 2007, which claims priority to U.S. Provisional Application No. 60/800,604, filed May 16, 2006, each of which are incorporated herein by reference in their entirety.

### STATEMENT REGARDING FEDERALLY SPONSORED RESEARCH OR DEVELOPMENT

Not applicable.

### STATEMENT REGARDING GOVERNMENT RIGHTS

Not Applicable.

### BACKGROUND OF THE INVENTION

(1) Field of the Invention

The present invention relates to conductive composite materials. More specifically, the present invention relates to high resistivity particles coated with exfoliated graphite particles which are incorporated into a polymer matrix which forms the composite material.

The exfoliated graphite coating on the particles improves the electrical properties of the resulting composite materials.

(2) Description of Related Art

Nanocomposites composed of polymer matrices comprising reinforcements of less than 100 nm in size, are being considered for applications such as interior and exterior accessories for automobiles, structural components for portable electronic devices, and films for food packaging (Giannelis, E. P., Appl. Organometallic Chem., Vol. 12, pp. 675 (1998); and Pinnavaia, T. J. et al., Polymer Clay Nanocomposites. John Wiley & Sons, Chichester, England (2000)). While most nanocomposite research has focused on exfoliated clay nanoplatelets, the same nanoreinforcement concept can be applied to another layered material, graphite, to produce nanoplatelets and nanocomposites (Pan, Y. X., et al., J. Polym. Sci., Part B: Polym. Phy., Vol. 38, pp. 1626 (2000); and Chen, G. H., et al., J. Appl. Polym. Sci. Vol. 82, pp. 2506 (2001)).

Graphite is the stiffest material found in nature (Young's Modulus=1060 MPa), having a modulus several times that of clay, but also with excellent electrical and thermal conductivity. With the appropriate surface treatment, exfoliation and dispersion in a thermoset or thermoplastic polymer matrix results in a composite with excellent mechanical, electrical and thermal properties, opening up many new structural applications as well as non-structural ones where electromagnetic shielding and high thermal conductivity are requirements as well. Furthermore, the economics of producing nanographite platelets indicate that a low cost is attainable. There is a need to improve the electrical properties with lowering of the amount of the graphite particles.

Graphite is a well known material occurring in natural and synthetic forms and is well described in the literature. Illustrative of this art is a monograph by Michel A. Boucher, Canadian Minerals Yearbook 24.1-24.9 (1994). A useful form of graphite is expanded graphite which has been known for years. The first patents related to this topic appeared as early as 1910 (U.S. Pat. Nos. 1,137,373 and 1,191,383). Since then, numerous patents related to the methods and resulting expanded graphites have been issued. For example, many patents have been issued related to the expansion process (U.S. Pat. Nos. 4,915,925 and 6,149,972), expanded graphite-polymer composites (U.S. Pat. Nos. 4,530,949, 4,704,231, 4,946,892, 5,582,781, 4,091,083 and 5,846,459), flexible graphite sheet and its fabrication process by compressing expanded graphite (U.S. Pat. Nos. 3,404,061, 4,244,934, 4,888,242, 4,961,988, 5,149,518, 5,294,300, 5,582,811, 5,981,072 and 6,143,218), and flexible graphite sheet for fuel cell elements (U.S. Pat. Nos. 5,885,728 and 6,060,189). Also there are patents relating to grinding/pulverization methods for expanded graphite to produce fine graphite flakes (U.S. Pat. Nos. 6,287,694, 5,330,680 and 5,186,919). All of these patents use a heat treatment, typically in the range of 600° C. to 1200° C., as the expansion method for graphite. The heating by direct application of heat generally requires a significant amount of energy, especially in the case of large-scale production. Radiofrequency (RF) or microwave expansion methods can heat more material in less time at lower cost. U.S. Pat. No. 6,306,264 to Kwon et al. discusses microwave as one of the expansion methods for SO₃ intercalated graphite in solution.

U.S. Pat. Nos. 5,019,446 and 4,987,175 describe graphite flake reinforced polymer composites and the fabrication method. These patents did not specify the methods to produce thin, small graphite flakes. The thickness (less than 100 nm) and aspect ratio (more than 100) of the graphite reinforcement was described.

Many patents have been issued related to anode materials for lithium-ion or lithium-polymer batteries (U.S. Pat. Nos. 5,344,726, 5,522,127, 5,591,547, 5,672,446, 5,756,062, and 6,136,474). Among these materials, one of the most widely investigated and used is graphite flakes with appropriate size, typically 2 to 50 μm, with less oxygen-containing functional groups at the edges. Most of the patents described graphite flakes made by carbonization of precursor material, such as petroleum coke or coal-tar pitch, followed by graphitization process.

Expanded graphite is formed by vaporizing a chemical intercalated in the graphite. In most cases, the chemical should be removed, preferably by heating, from the graphite before mixing with polymers, since the chemical can degrade polymers. The expanded graphite can be formed in a radiofrequency wave applicator by heating the graphite precursor with microwave or radiofrequency waves. In some embodiments, a precursor graphite has been treated with a fuming oxy acid and heated to form the expanded graphite. The expanded graphite is then pulverized.

U.S. Pat. Nos. 4,777,336 to Asmussen et al., 5,008,506 to Asmussen, 5,770,143 to Hawley et al., and 5,884,217 to Hawley et al. describe various microwave or radiofrequency wave systems for heating a material. These systems can be used to exfoliate the intercalated graphite. These applications and patents are hereby incorporated herein by reference in their entirety.

Generally, fibers and fillers are used to reinforce polymeric matrix to form a composite with high strength or stiffness. Conductive filler reinforced composites add functionality and broaden the application fields. Conductive coatings also include conductive filler reinforced polymeric composites that are conductive for various applications.

U.S. Pat. No. 5,447,791 describes methods to add conductive filler at the start stage of polymerization process to form conductive composition. Conductive filler include carbon black and metal oxides such as iron oxides, titanium oxide, tin dioxide and metal powders. No carbon based nanomaterials were involved.

U.S. Pat. Nos. 6,533,963, 6,013,203, 6,894,100, 6,689,835 and 6,919,394 describe use polymer or rubber as matrix with conductive filler to make conductive composition for EMI and RFI shielding. The filler used is metal filler. The conductive articles made from these compositions can therefore be used for electromagnetic shielding, electrostatic dissipation or antistatic purposes in packaging, electronic components, housings for electronic components and automotive housings. These conductive fillers used include metallic fiber, metal oxide, conductive carbon black, a carbon nanotube, a carbon nanofiber, a carbon fiber and graphite. However, no carbon based nanomaterials such as xGnP were used as conductive filler in these composites even if the graphite was not the exfoliated graphite nanoplatelets used in the present invention.

Conductive polymers also can be used as coating composition. U.S. Pat. No. 6,905,141 describes glass elements with a transparent conductive polymer for the purpose of reducing surface resistance for use in the assembly of equipment, installations and for pipe works. US. Patent Nos. 6,342,273 and 6,776,928 use electrostatic painting methods coating a substrate with a powder paint composition.

Conductive coatings normally involve a conductive filler or conductive pigment, solvent, binder or conductive polymer to form a solution for coating substrate that will have certain conductivity for various applications. U.S. Pat. No. 6,736,997 describes a resistive and conductive coating with Sol-gel method to form an electrically conductive coating layer or film on a substrate for isolation and conductive application. Similarly U.S. Pat. Nos. 5,447,791, 5,130,177, 5,041,242, 4,714,569, 4,209,425, 4,589,999 and 4,547,311 describe conductive coating compositions using conductive fillers such as graphite, carbon black and so on. But the graphite used is not exfoliated graphite nanoplatelets. These compositions can be used for coating substrate such as paper, conductive cores and other surfaces for functional use.

U.S. Patent application No. 0040121152 used a gypsum or portland as cement layer to coat a glass fiber substrate and fiberglass board with an aqueous dispersion of vermiculite and expandable graphite for flame-resistant insulation. The resulting coated insulation board has superior flame resistance, and can be used as a component of a building or in vehicles. However, conductive coatings were not mentioned in this patent and the coated fiber did not show any electrical properties. In addition, U.S. Patent application Nos. 0040188046, 5,968,669, 5,972,434, and 4,911,972 describes fibers mixed with graphite as insulating materials for flame resistance or insulating gasket applications. These applications used the expansion of graphite by heat.

### SUMMARY OF THE INVENTION

The present invention provides a reinforced composite material which comprises: a polymeric matrix; and a plurality of graphite coated particles mixed in the polymeric matrix, each of the coated particles comprising a high resistivity particle having an outer surface, and exfoliated and pulverized graphite platelets having a particle size between about 0.1 and 500 microns coated on the outer surface of the particles by a binder, wherein the reinforced composite material enables electrostatic painting. In further embodiments, the particle comprises an inorganic composition. In still further embodiments, a weight fraction of exfoliated graphite platelets on the outer surface of the particle is from about 0.05 to about 20 wt % of the weight of the particles. In further still embodiments, the polymeric matrix comprises a thermoset or thermoplastic organic polymer. In further still embodiments, the matrix comprises the graphite platelets independent of the particles. In still further embodiments, the particles are calcium carbonate. In further still embodiments, the matrix comprises the graphite platelets independent of the particles and wherein the particles are calcium carbonate coated with the graphite.

The present invention further provides a method of electrostatic painting a reinforced composite material without using a conductive primer comprising the steps of: providing an electrically conductive reinforced composite material which comprises a polymeric matrix; and a plurality of graphite coated particles mixed in the polymeric matrix, each of the coated particles comprising a high resistivity particle having an outer surface; and exfoliated and pulverized graphite platelets having a particle size between about 0.1 and 500 microns coated on the outer surface of the particles by a binder to provide the graphite coated particle, wherein the reinforced composite material has sufficient conductivity to undergo electrostatic painting and to provide EMI and RF shielding; electrically grounding the reinforced composite material; providing a charged powder comprising a resin and a pigment; spraying the charged powder onto the electrically grounded reinforced composite material so as to coat the material; and curing the powder on the reinforced composite material in a curing oven, so as to electrostatically paint the reinforced composite material with the powder. In further embodiments, the particles comprise an inorganic composition. In further still embodiments, a weight fraction of the graphite platelets on the outer surface of the particles is from about 0.05 to about 20 wt % of the weight of the particles. In still further embodiments, the polymer matrix comprises a thermoset or thermoplastic polymer. In further still embodiments, the matrix comprises the graphite platelets independent of the particles. In further embodiments, the particles are calcium carbonate. In still further embodiments, the matrix comprises the graphite platelets independent of the particles and wherein the particles are calcium carbonate coated with the graphite.

The present invention still further provides a low resistivity graphite coated high resistivity particle comprising: an electrically insulating particle having an outer surface; and exfoliated and pulverized graphite platelets having a particle size between about 0.1 and 500 microns coated on the outer surface of the electrically insulating particle by a binder to provide the low resistivity graphite coated high resistivity. In further embodiments, the particle comprises an inorganic composition. In further still embodiments, a weight fraction of exfoliated graphite platelets on the outer surface of the particle is from about 0.05 to about 20 wt % of the weight of the particles.

The present invention further still provides a method of making a plurality of low resistivity graphite coated particles comprising the steps of: providing a plurality of high resistivity particles; providing a graphite solution comprising exfoliated and pulverized graphite particles having a particle size between about 0.1 and 500 microns mixed in a binder solution; coating the plurality of particles in the graphite solution; removing the excess graphite solution from the particles; and drying the coated particles to provide the low resistivity graphite coated particles. In further embodiments, the graphite particles are ultrasonically mixed in the binder solution to provide the graphite solution. In further still embodiments, the particles are coated in the graphite solution for about 1 to about 3600 seconds. In still further embodiments, the graphite solution has a graphite concentration of between about 0.05 and 15 wt % of the solution. In still further embodiments, the particles are dried at room temperature.

The present invention further still provides a method of making a plurality of low resistivity graphite coated particles comprising the steps of: providing a plurality of high resistivity particles; providing a graphite solution comprising exfoliated and pulverized graphite particles having a particle size between about 0.1 and 500 microns in a binder solution; coating the plurality of the particles with a graphite solution; and drying the particles to remove the solution to thereby provide the low resistivity graphite coated particles.

The present invention still further provides a method of making a plurality of low resistivity graphite coated particles comprising the steps of: providing a plurality of high resistivity particles; providing a graphite solution comprising exfoliated and pulverized graphite particles having a particle size between about 0.1 and 500 microns mixed in a binder solution; repeatedly coating the graphite solution onto the plurality of the particles for a time to provide coated particles with multiple layers of the graphite platelets; and drying the coated particles after each coating to provide the low resistivity graphite coated particles. In further embodiments, the graphite solution is 1 wt % of the exfoliated and pulverized graphite in the binder solution. In further still embodiments, the coated particles are dried at room temperature for more than twelve hours. In still further embodiments, the coating time is for about 1800 seconds with mixing of the graphite solution.

### BRIEF DESCRIPTION OF DRAWINGS

FIGS. 1A to 1F are ESEM images of calcium carbonate with or without the xGnP coating. A=is an ESEM image of CaCO₃; B=7% xGnP-1 coated CaCO₃; C=10% xGnP-1 with PSSS coated CaCO₃; D=10% xGnP-1 with PSMA coated CaCO₃; E=0.7% xGnP-1 with PSMA coated CaCO₃; F=5% xGnP-1 with PSMA coated CaCO₃.

FIG. 2 is a graph showing resistivity of xGnP-coated calcium carbonate reinforced unsaturated polyester. A=0% CaCO₃+100% (UPE/0% xGnP-1)=composite (xGnP 0%); B=0% CaCO₃+100% (UPE/4% xGnP-1)=composite (xGnP 4.0%); C=40% CaCO₃/+7% xGnP-1)+60% UPE=composite (xGnP 2.8%); D=50% CaCO₃/7% xGnP-1)+50% UPE=composite (xGnP 3.5%); E=50% CaCO₃/10% GnP-1)+50% UPE=composite (xGnP 5.0%).

FIG. 3 is a graph showing resistivity of xGnP-1 coated calcium carbonate reinforced unsaturated polyester. A=0% (CaCO₃/0% xGnP-1)+100% (UPE/2% xGnP-15)=composite (xGnP2%); B=0% (CaCO₃/0% xGnP-1)+100% (UPE/4% xGnP-15)=composite (xGnP4.0%); C=29% (CaCO₃/0% xGnP-1)+71% (UPE/5.6% xGnP-15)=composite (xGnP4.0%); D=30% (CaCO₃/7% xGnP-1)+70% (UPE/1.3% xGnP-15)=composite (xGnP3.0%); E=30% (CaCO₃/7% xGnP-1)+70% (UPE/1.7% xGnP-15)=composite (xGnP3.3%); F=29% (CaCO₃/7% xGnP-1)+71% (UPE/2.8% xGnP-15)=composite (xGnP4.0%); G=29% (CaCO₃/7% xGnP-1)+71% (UPE/5.5% xGnP-15)=composite (xGnP5.9%).

FIG. 4 is a schematic of filler particle (filler) with carbon based nanomaterials such as xGnP.

### DESCRIPTION OF THE PREFERRED EMBODIMENTS

All patents, patent applications, government publications, government regulations, and literature references cited in this specification are hereby incorporated herein by reference in their entirety. In case of conflict, the present description, including definitions, will control.

As used herein the abbreviation “PSSS” refers to anionic (−) poly(sodium 4-styrene sulfonate), which is a vinyl polymer.

As used herein the abbreviation “PSMA” refers to poly(styrene-co-maleic anhydride).

As used herein the abbreviation “PDAC” refers to cationic (+) poly(diallyldimethylammonium chloride), which is a vinyl polymer.

As used herein the term “anionic polyelectrolyte” refers to any anionic polymer known in the art, including but not limited to poly(sodium 4-styrene sulfonate) (PSSS). The term “anionic polymer” refers to any polymer, organic or inorganic, having repeating subunits with negatively charged groups along the polymer chain. This is one of the binders.

As used herein the term “cationic polyelectrolyte” refers to any cationic polymer known in the art, including but not limited to poly(diallyldimethylammonium chloride) (PDAC). The term “cationic polymer” refers to any polymer, organic or inorganic, having repeating subunits with positively charged groups along the polymer chain. This is an alternative binder.

As used herein the term “resistivity particle” refers to any particle with an electrical resistance that increases with decreasing frequency. Some examples include chemical compositions such as calcium carbonate and various forms of alumina and silica. The particle preferably has a length between about 1 μm and 200 μm and a width between about 1 um and 200 μm.

As used herein the term “low resistivity graphite coated particles” refers to a particle coated with exfoliated and pulverized graphite platelets that has a resistivity at a frequency of 1 Hz that is lower than the resistivity of an untreated (raw) particle.

As used herein the term “reinforced composite material” refers to a composite material having added reinforcements. The composite material can comprise any thermoset or thermoplastic polymeric matrix known in the art.

As previously discussed, graphite is a layered material that is a very good thermal and electrical conductor. Individual molecular layers of graphite are held together with weak Van der Waals forces that are capable of being intercalated with organic or inorganic molecules. The intercalated molecules can be used for separation of the graphite layers to form expanded graphite. An expanded graphite is one that has been heated to separate individual platelets of graphite. An exfoliated graphite is a form of expanded graphite where the individual platelets are separated by heating with or without an agent such as a polymer or polymer component. The graphite expands to form very large platelets having large diameters and very thin thicknesses. The expanded graphite usually does not have any significant order as evidenced by x-ray diffraction patterns. The exfoliated graphite is pulverized to form the platelets, particularly nanographite platelets. As used herein the abbreviation “xGnP” refers to exfoliated nanographite platelets. Exfoliated nanographite platelets (xGnP) are exfoliated and pulverized graphite to a particle size between about 0.1 and 500 microns.

Expanded graphite results in superior mechanical properties and in addition has desirable electrical properties if a sufficient amount of the expanded graphite is present in a polymer matrix. Expanded graphite platelets have interbasal plane surfaces with reactive sites on the edges of the platelets. Different chemical groups can be added to the edges. The application of an electric field can also be used to orient the expanded graphite platelets in a preferred direction creating materials which are electrically or thermally conductive in one direction. Submicron conductive paths can thus be created to act as nanosized wires.

The use of microwave (MW) energy or radiofrequency (RF) induction heating provides a fast and economical method to produce expanded graphite nanoflakes, graphite nanosheets, or graphite nanoparticles. The microwave or radiofrequency methods are especially useful in large-scale production and are very cost-effective. The combination of radiofrequency or microwave expansion and appropriate grinding technique, such as planetary ball milling (and vibratory ball milling), produces nanoplatelet graphite flakes with a high aspect ratio efficiently. Microwave or radiofrequency expansion and pulverization of the crystalline graphite to produce suitable graphite flakes enables control of the size distribution of graphite flakes more efficiently. By incorporating an appropriate surface treatment, the process offers an economical method to produce a surface treated expanded graphite.

Chemically intercalated graphite flakes are expanded by application of the radiofrequency or microwave energy. The expansion occurs rapidly. Heating for three to five minutes removes the expanding chemical. The graphite absorbs the radiofrequency or microwave energy very quickly without being limited by convection and conduction heat transfer mechanisms. The intercalant heats up past the boiling point and causes the graphite to expand to many times its original volume. The process can be performed continuously by using a commercially available induction or microwave system with conveyors. Although a commercial microwave oven operating at 2.45 GHz was used for the following experiments, radio frequency (induction heating) or microwave frequency energy across a wide range can be used for this purpose.

The expanded graphite is pulverized for instance by ball milling, mechanical grinding, air milling, or ultrasonic wave to produce graphite flakes (platelets) with high aspect ratio. These flakes are used as reinforcements in various matrices including polymers and metals. Also these flakes can be used, for instance, as anode materials, or substrates for metal catalysts. The exfoliated graphite flakes can be provided in a polymer matrix composite to improve the mechanical, electrical and thermal properties. In some embodiments the intercalated graphite flakes are expanded by application of microwave energy at 2.45 GHz. Exfoliated and pulverized graphite and methods of producing the exfoliated and pulverized graphite are described in U.S. Patent Application Publication No. 2004/0127621 to Drzal et al. (copending U.S. patent application Ser. No. 10/659,577), filed Sep. 10, 2003, assigned to a common assignee, hereby incorporated herein by reference in its entirety. This microwave expansion process can be done continuously by using a commercially available microwave system with conveyors or the other devices as described in U.S. patent application Ser. No. 11/435,350, filed May 16, 2006, assigned to a common assignee, hereby incorporated herein by reference in its entirety.

Natural graphite was exfoliated to produce nano sized platelets of graphite that can be dispersed in either organic or water based systems. In experiments conducted with both thermoset and thermoplastic polymers described in these applications, exfoliated graphite nanoplatelets (xGnP) have been successfully dispersed and their mechanical, electrical, barrier and thermal properties have been measured. It was found that as little as three (3) volume percent of the xGnP reduced the AC impedance by a factor of 10⁹-10¹⁰, a level sufficient to not only provide electrostatic charge dissipation, but also to decrease the electrical resistance to the point where the polymer composite has sufficient conductivity to undergo electrostatic painting and to function for electromagnetic interference (EMI) shielding. There was a need for reduced amounts of the graphite with high resistivity in the composite material.

The composite material can be applied to thermoset polymer systems, such as epoxy, polyurethane, polyurea, polysiloxane and alkyds, where polymer curing involves coupling or crosslinking reactions. The composite material can be applied as well to thermoplastic polymers for instance polyamides, proteins, polyesters, polyethers, polyurethanes, polysiloxanes, phenol-formaldehydes, urea-formaldehydes, melamine-formaldehydes, celluloses, polysulfides, polyacetals, polyethylene oxides, polycaprolactams, polycaprolactons, polylactides, polyimides, and polyolefins (vinyl-containing thermoplastics). Specifically included are polypropylene, nylon and polycarbonate. The polymer can be for instance an epoxy resin. The epoxy resin cures when heated. The epoxy composite material preferably contains less than about 8% by weight of the expanded graphite platelets. Thermoplastic polymers are widely used in many industries. Generally, the amount is less than about 30% by weight of the composite material.

Nanolayers of the exfoliated graphite on high resistivity particles and their efficacy at improving the conductivity of the coated particles are described in the following Examples. The effect of nanographite platelet size, concentration and surface chemistry on the conductivity of particles is also described. These results can be extended to the particle sizing/finish solution to produce a level of conduction on particles applicable to production methods. Furthermore, the electrical conductivity, mechanical properties and processability of the selected formulation (SMC or thermoplastic system) of the xGnP coated particles can be optimized.

The present invention specifically relates to coating with exfoliated graphite nanoplatelets (xGnP) that produce particles having multi-functionality such as electric, magnetic, optical, thermal, mechanical and spectral response. A certain level of electrical conductivity makes the coated particles useful as part of an electrical device. The optical and spectral response can make coated fiber or fillers capable of providing information about their physical or chemical environment. Thermal and mechanical response makes coated particle reinforced composites having super physical properties. Combining these two features produces a coated particle capable of acting as a sensor in a reinforced composite system. Since the carbon-based nanomaterials lie in the interface between the particles and the matrix, it can be used as a mechanical sensor to detect the structural changes in the composites. In addition, coated particle reinforced composites have excellent electrical conductivity with a lower level of xGnP concentration in the composites that is required to provide electrostatic discharge (ESD) and electro magnetic interference (EMI) shielding. Therefore the graphite coated particles as well as their reinforced composites have multiple applications.

The particles are coated by a process that utilizes electrostatic interaction, hydrogen bonding and capillary forces combine with polyelectrolyte solutions and water based xGnP solutions, solvent based xGnP binder solutions or suspensions. It is necessary to prepare xGnP water based solution or solvent based xGnP suspension for coating the particles. Polyelectrolytes used here include poly(sodium 4-styrene sulfonate) (PSSS), poly(diallyldimethylammonium chloride) (PDAC) and poly(ethylenimine) (PEI) and sodium dodecylbenzene sulfonate (SDBS) was used as surfactant. Binders used here include block, graft and alternative copolymer that can have interaction with both fillers and carbon based nanomaterials like poly(strene-co-maleic anhydride) alternative copolymer. Dip and spray coating is the main processing method. The structure, morphology and physical properties, include the electric, magnetic, optical, thermal, mechanical and spectrum, of the coated particles and reinforced composites were evaluated.

### EXAMPLES

### Example 1

### Coating of Calcium Carbonate with xGnP-1

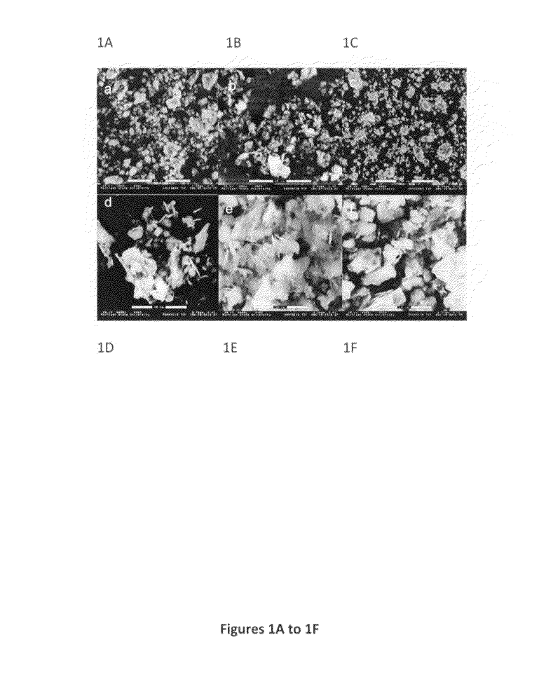

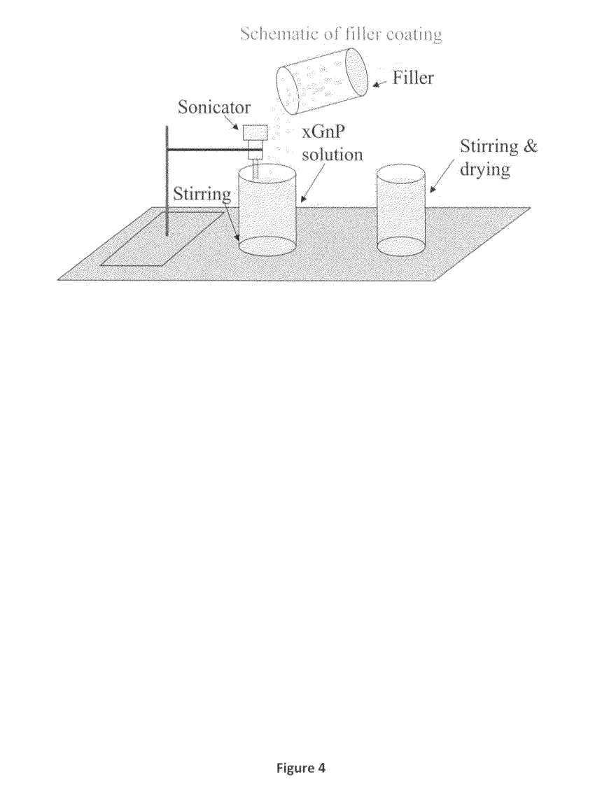

Calcium carbonate, talc and other particulate fillers and reinforcements are combined with polymers to produce composites and nanocomposites in order to reduce the cost and increase the mechanical properties. Applying on the surface of these particles or reinforcements can add more functionality such as electrical properties, magnetic properties, and spectrum response and further act an important role in reinforced composite system. The coating of inorganic fillers such as calcium carbonate with xGnP involves using binders to form an xGnP solvent based suspension or polyelectrolytes to form water based xGnP solution. Binders used here include block, graft and alternative copolymer that can have interaction with both fillers and carbon based nanomaterials. Poly (styrene-co-maleic anhydride) (PSMA) is an example here for coating xGnP on the surface of CaCO₃. The filler was slowly added to the xGnP suspension, as shown in FIG. 4, with stirring. After a short period, the xGnP-coated filler was produced with stirring. The ESEM images of these coated CaCO₃ are shown in FIGS. 1A to 1F. It was found that the coating conditions could be varied between CaCO₃ with 10% xGnP with PSMA as binder in an acetone system or CaCO₃ with xGnP and Poly (sodium 4-styrene sulfonate) (PSSS) in a water system.

### Example 2

### Electrical Resistivity of Coated Fillers Reinforced Composite

Due to the fact that there are no direct methods to test the conductivity of these coated fillers, it is necessary to prepare coated filler reinforced composites so as to measure the conductivity of composite for evaluating the conductivity of those coated filler and coating condition. Here unsaturated polyester resin was used as matrix to prepare coated filler reinforced composite. First xGnP-15 (average particle size 15 microns) was added to the unsaturated polyester (UPE) resin solution with stirring and sonication for some time. Then CaCO3 filler was coated with xGnP-1 and was added to the xGnP-15 reinforced UPE resin solution and stirred for sometime. Finally, initiator was added to the system and stirred for a while. The well-mixed resin solution was poured into a mold which was placed into a forced air oven for curing at 110° C. for 2 hours and post curing at 150° C. for 2 hours. The electrochemical impedance spectrum over a range of frequencies of these composite was measured with a Gamry Instruments (Warminster, Pa.) under FAS2™ Femtostat plug system (Warminster, Pennysylvania) and potentiostatic mode. The impedance value at 1 Hz was used to calculate the resistivity of the composite.

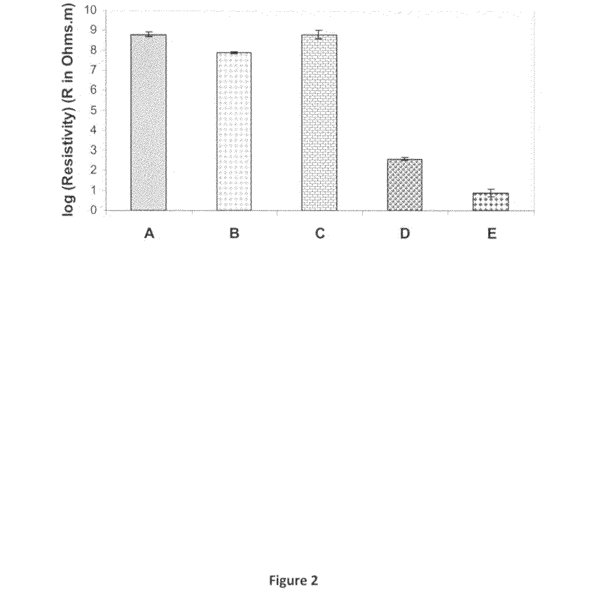

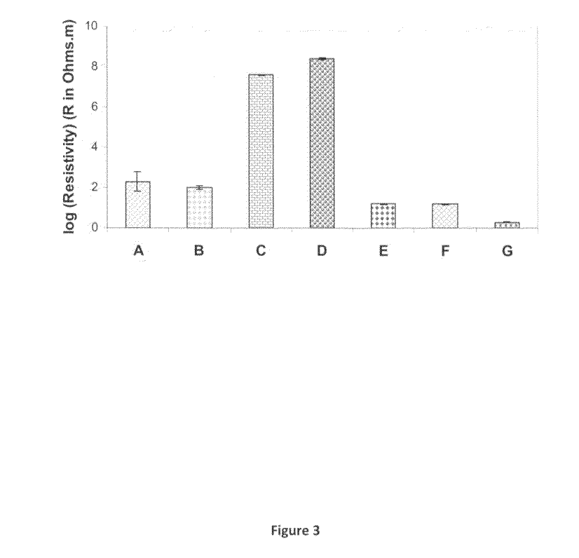

Coating xGnP on the surface of CaCO₃ makes the percolation threshold of xGnP in the composite for electrical conductivity shift to a low level (FIG. 2). This implies that the coating of xGnP-15 on the particles does help to improve the conductivity of the hybrid composite. 2% xGnP-15 coated in calcium carbonate reinforced UPE composites is conductive, but adding 30% CaCO₃, along with 4% xGnP-15 reinforced UPE hybrid composite is not conductive (FIG. 3). 30% graphite coated CaCO₃ was added to xGnP-15 reinforced UPE system to make a conductive composite. The conductivity depends on the content of xGnP-15 in the composite. Once the content of xGnP-15 was above 1.2% coated on the CaCO₃ or the content of total xGnP was above 3.3% in the system, the composite became conductive. Using this method, it was found that coating of the surface of CaCO₃ required much less xGnP to make the composite conductive. Theoretically, the weight fraction of the monolayer of xGnP on the surface of CaCO₃ is 1.1% by weight of the particles. The best coating was 10% xGnP-1 by weight of the particles of CaCO₃, which suggests the equivalent of 9 monolayers of xGnP-1 coating on CaCO₃ was the optimum condition as shown by the conductivity of the 10% xGnP coated CaCO₃ reinforced composite.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the Claims attached herein.

We claim:

1. A reinforced composite material which comprises:
(a) a polymeric matrix; and
(b) a plurality of graphite coated particles mixed in the polymeric matrix, each of the coated particles comprising a high resistivity particle having an outer surface, and exfoliated and pulverized graphite platelets having a particle size between about 0.1 and 500 microns coated on the outer surface of the particles by a binder, wherein the reinforced composite material enables electrostatic painting.

2. The reinforced composite material of claim 1, wherein the particle comprises an inorganic composition.

3. The reinforced composite material of claim 2, wherein a weight fraction of exfoliated graphite platelets on the outer surface of the particle is from about 0.05 to about 20 wt % of the weight of the particles.

4. The reinforced composite material of claim 1, wherein the polymeric matrix comprises a thermoset or thermoplastic organic polymer.

5. The composite of any one of claims 1, 2, 3 or 4, wherein the matrix comprises the graphite platelets independent of the particles.

6. The composite of any one of claims 1, 2, 3 or 4, wherein the particles are calcium carbonate.

7. The composition of any one of claims 1, 2, 3 or 4, wherein the matrix comprises the graphite platelets independent of the particles and wherein the particles are calcium carbonate coated with the graphite.

8. A method of electrostatic painting a reinforced composite material without using a conductive primer comprising the steps of:
(a) providing an electrically conductive reinforced composite material which comprises a polymeric matrix; and a plurality of graphite coated particles mixed in the polymeric matrix, each of the coated particles comprising a high resistivity particle having an outer surface; and exfoliated and pulverized graphite platelets having a particle size between about 0.1 and 500 microns coated on the outer surface of the particles by a binder to provide the graphite coated particle, wherein the reinforced composite material has sufficient conductivity to undergo electrostatic painting and to provide EMI and RF shielding;
(b) electrically grounding the reinforced composite material;
(c) providing a charged powder comprising a resin and a pigment;
(d) spraying the charged powder onto the electrically grounded reinforced composite material so as to coat the material; and
(e) curing the powder on the reinforced composite material in a curing oven, so as to electrostatically paint the reinforced composite material with the powder.

9. The method of claim 8, wherein the particles comprise an inorganic composition.

10. The method of claim 8, wherein a weight fraction of the graphite platelets on the outer surface of the particles is from about 0.05 to about 20 wt % of the weight of the particles.

11. The method of claim 8, wherein the polymer matrix comprises a thermoset or thermoplastic polymer.

12. The method of any one of claims 8, 9, 10 or 11, wherein the matrix comprises the graphite platelets independent of the particles.

13. The method of any one of claims 8, 9, 10 or 11, wherein the particles are calcium carbonate.

14. The method of any one of claims 8, 9, 10 or 11, wherein the matrix comprises the graphite platelets independent of the particles and wherein the particles are calcium carbonate coated with the graphite.

15. A low resistivity graphite coated high resistivity particle comprising:
(a) an electrically insulating particle having an outer surface; and
(b) exfoliated and pulverized graphite platelets having a particle size between about 0.1 and 500 microns coated on the outer surface of the electrically insulating particle by a binder to provide the low resistivity graphite coated high resistivity.

16. The low resistivity graphite coated particle of claim 15, wherein the particle comprises an inorganic composition.

17. The low resistivity graphite coated particle of claim 16, wherein a weight fraction of exfoliated graphite platelets on the outer surface of the particle is from about 0.05 to about 20 wt % of the weight of the particles.

18. A method of making a plurality of low resistivity graphite coated particles comprising the steps of:
(a) providing a plurality of high resistivity particles;
(b) providing a graphite solution comprising exfoliated and pulverized graphite particles having a particle size between about 0.1 and 500 microns mixed in a binder solution;
(c) coating the plurality of particles in the graphite solution;
(d) removing the excess graphite solution from the particles; and
(e) drying the coated particles to provide the low resistivity graphite coated particles.

19. The method of claim 18, wherein the graphite particles are ultrasonically mixed in the binder solution to provide the graphite solution in step (b).

20. The method of claim 18, wherein the particles are coated in the graphite solution for about 1 to about 3600 seconds.

21. The method of claim 18, wherein the graphite solution has a graphite concentration of between about 0.05 and 15 wt % of the solution.

22. The method of claim 18, wherein the particles are dried in step (e) at room temperature.

23. A method of making a plurality of low resistivity graphite coated particles comprising the steps of:
(a) providing a plurality of high resistivity particles;
(b) providing a graphite solution comprising exfoliated and pulverized graphite particles having a particle size between about 0.1 and 500 microns in a binder solution;
(c) coating the plurality of the particles with a graphite solution; and
(d) drying the particles to remove the solution to thereby provide the low resistivity graphite coated particles.

24. A method of making a plurality of low resistivity graphite coated particles comprising the steps of:
(a) providing a plurality of high resistivity particles;
(b) providing a graphite solution comprising exfoliated and pulverized graphite particles having a particle size between about 0.1 and 500 microns mixed in a binder solution;
(c) repeatedly coating the graphite solution onto the plurality of the particles for a time to provide coated particles with multiple layers of the graphite platelets; and
(d) drying the coated particles after each coating to provide the low resistivity graphite coated particles.

25. The method of claim 24, wherein the graphite solution is 1 wt % of the exfoliated and pulverized graphite in the binder solution.

26. The method of claim 24, wherein the coated particles are dried in step (d) at room temperature for more than twelve hours.

27. The method of claim 24, wherein the coating time in step (c) is for about 1800 seconds with mixing of the graphite solution.
